(19) United States
(12) Patent Application Publication
(10) Pub. No.: US 2009/0135928 A1
(43) Pub. Date: May 28, 2009

(54) DEVICE, APPARATUS, AND METHOD FOR LOW-POWER FAST FOURIER TRANSFORM

(76) Inventors: Young-Beom Jang, Seoul (KR); Won-Sang Lee, Seoul (KR); Do-Han Kim, Incheon (KR); Bee-Chul Kim, Seoul (KR); Eun-Sung Hur, Seoul (KR)

Correspondence Address: FOLEY & LARDNER LLP, 150 EAST GILMAN STREET, P.O. BOX 1497, MADISON, WI, 53701-1497, US

(21) Appl. No.: 12/161,132

(22) PCT Filed: Jan. 16, 2007
(86) PCT No.: PCT/KR07/00264

§ 371 Date: Oct. 15, 2008

(30) Foreign Application Priority Data
Jan. 17, 2006 (KR) 10-2006-0004741

(51) Int. Cl. H04L 27/28; G06F 17/14; G06F 5/01

(52) U.S. Cl. 375/260; 708/404; 708/209; 375/316

(57) ABSTRACT

A device, apparatus and method for performing a Fast Fourier Transform (FFT). The Fast Fourier Transform (FFT) processing device includes a coefficient generator, a memory, and an accumulator. The coefficient generator is configured to generate a first set of coefficient values from one or more twiddle factor coefficients. The memory stores the first set of coefficient values. The accumulator receives and accumulates one or more coefficient values from the first set of coefficient values, the accumulator generating one or more output values based on the accumulated one or more coefficient values.

### BRIEF DESCRIPTION OF THE DRAWINGS

FIG. 1 shows a wireless network system where mobile terminals or base stations according to an embodiment can be employed.

FIG. 2 shows a schematic block diagram of an OFDM receiver according to one embodiment.

FIG. 3 shows an exemplary distributed arithmetic block that performs multiplication operations by using a distributed arithmetic in an FFT processor in accordance with one embodiment.

FIG. 4 illustrates a schematic diagram of an FFT processor implementing a 64-point radix-4 decimation-in-frequency FFT in accordance with one embodiment.

FIG. 5 is a schematic flow chart showing a method for performing an FFT operation in accordance with one embodiment.

FIG. 6 shows a more detailed schematic diagram of an FFT processing unit illustrating input and output signals in accordance with one embodiment.

FIG. 7 shows a block diagram of an FFT processing unit for performing FFT operations in accordance with one embodiment.

FIG. 8 shows a more detailed schematic diagram of a first operation unit according to one embodiment.

FIG. 9 shows a more detailed schematic diagram of a second operation unit according to one embodiment.

FIG. 10 shows a more detailed schematic diagram of a butterfly distributed arithmetic unit according to one embodiment.

### BACKGROUND

With the development of digital broadcasting technology and mobile communication technology, digital broadcasting services that enable a user to view digital broadcasts even while the user is in transit is becoming increasingly popular. For example, one of the digital broadcasting technology called digital multimedia broadcasting (“DMB”) for a mobile communication terminal has been available in some parts of the world. The DMB service is a high-speed broadcasting service that makes it possible for a user to view multimedia broadcasts on multiple channels through a personal portable receiver or a receiver for vehicles having a non-directional receiving antenna even when the user or the vehicle is in motion.

In general, high-speed multimedia systems such as a DMB system transmit and receive data by using Orthogonal Frequency Division Multiplex (OFDM) modulation. In such systems, the OFDM modulation provides a number of advantages such as high spectrum efficiency, resistance against multi-path interference (particularly in wireless communications), and ease of filtering out undesired noise.

In an OFDM transmission system, the transmitter side performs a serial-to-parallel conversion on a signal to be transmitted, performs inverse fast Fourier transformation (IFFT) on the parallel data by multiplying the data with sub-carrier waves, and transmits the resultant signal.

A receiver side receives the transmitted signal and performs a serial-parallel conversion on the signal. The receiver then performs a fast Fourier transformation (FFT) on the converted signal and decodes the signal to acquire the original signal.

### SUMMARY

Consistent with the foregoing, and in accordance with the invention as embodied and broadly described herein, a fast Fourier Transform (FFT) processing device is disclosed in one embodiment in accordance with the invention as including a coefficient generator, a memory, and an accumulator. The coefficient generator is configured to generate a first set of coefficient values from one or more twiddle factor coefficients. The memory stores the first set of coefficient values. The accumulator receives and accumulates one or more coefficient values from the first set of coefficient values, the accumulator generating one or more output values based on the accumulated one or more coefficient values.

### DETAILED DESCRIPTION

In the following description, numerous specific details are set forth in order to provide a thorough understanding of particular embodiments. It will be apparent, however, to one skilled in the art, that various other embodiments may be practiced without some or all of these specific details. In other instances, well known process units or steps have not been described in detail to avoid unnecessarily obscuring this disclosure.

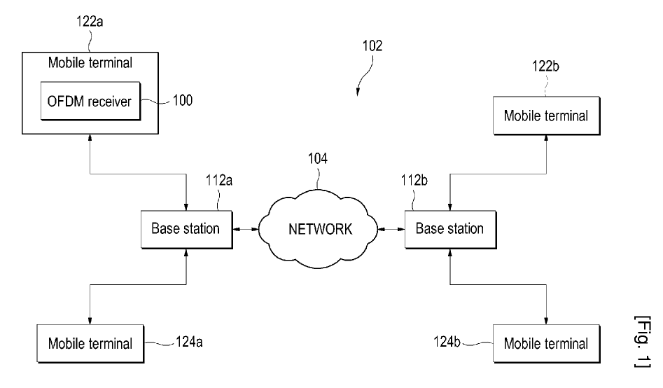

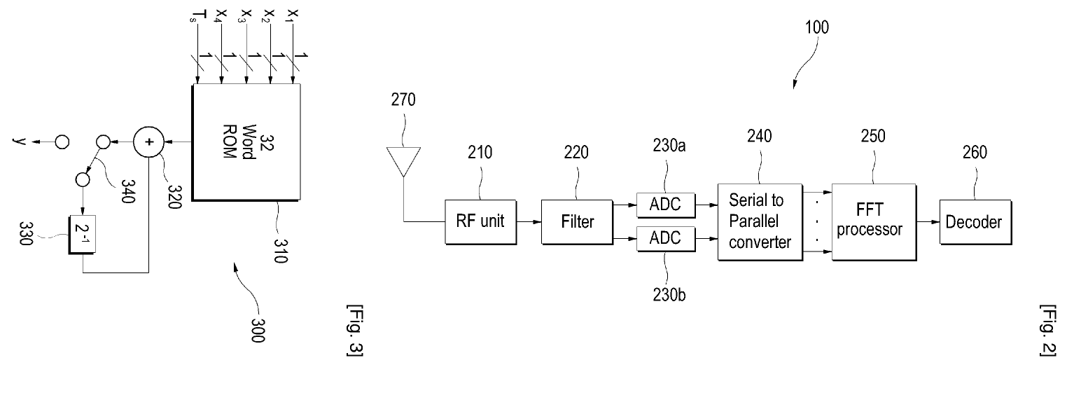

FIG. 1 shows a wireless network system 102 where mobile terminals 122a-124b or base stations 112a-b according to an embodiment can be employed. The mobile terminals 122a-b and 124a-b are mobile communication receivers and include OFDM receivers to transmit and receive data, which will be explained below with reference to FIG. 2. The mobile terminals 122a and 124a can communicate with the base station 122a or with other mobile terminals 122b and 124b via the base station 112a, the wireless network 104 and the base station 112b.

FIG. 2 shows a schematic block diagram of an exemplary OFDM receiver 100 according to one embodiment. The OFDM receiver 100 can be implemented in base stations 112a-b or in mobile terminals 122a-b and 124a-b such as mobile phones.

As shown in FIG. 2, this embodiment of the OFDM receiver 100 includes an RF unit 210, a filter 220, Analog-to-Digital Converters (ADCs) 230a and 230b, a serial-to-parallel converter 240, an FFT processor 250, a decoder 260, and an antenna 270. Those skilled in the art will recognize that the OFDM receiver 100 may additionally include other components such as an Interpolation/decimation filter block, a Viterbi block, an equalization block or some combination thereof. In addition, some components may be omitted from the OFDM receiver 100 in other embodiments.

The OFDM receiver 100 receives RF signals that are transmitted by a complementary OFDM transmitter via the antenna 270. The output of the antenna is coupled to the RF unit 210, which downconverts the received OFDM signals to baseband OFDM signals and outputs the converted OFDM signals to the filter 220.

The filter 220 separates the OFDM baseband signals into I channel (real part) OFDM signals and Q channel (imaginary part) OFDM signals, and outputs the I and Q channel signals to the ADC 230a and the ADC 230b, respectively. Specifically, the ADC 230a receives the I channel signals and converts the signals to digital signals while the ADC 230b receives the Q channel signals and converts the signals to digital signals. The serial-to-parallel converter 240 is coupled to receive the digital signals from the ADCs 230a and 230b and converts the digital signals received serially from the ADCs 230a and 230b to a plurality of parallel data sequences.

The FFT processor 250 is coupled to receive the I and Q channel parallel data sequences from the serial-to-parallel converter 240 and performs the FFT on the parallel data sequences. The decoder 260 receives the FFT-transformed I channel and Q channel data from the FFT processor 250 and decodes the data to obtain transmission data.

In the following, an FFT method performed in the FFT processor 250 according to one embodiment will be explained in detail. A fast Fourier transform (FFT) is an efficient algorithm to compute the discrete Fourier transform (DFT) and its inverse. Generally, the computational problem for the DFT is to compute the sequence {X(k)} of N complex-valued numbers given another sequence of data {x(n)} of length N, according to the formula:

$$X ( k ) = {\sum }_{n = 0}^{N - 1} x ( n ) {W}_{N}^{kn} , 0 \underline{<} k \underline{<} N - 1$$

$${W}_{N} = {e}^{- j2 π / N}$$

where n is a time index, k is a frequency index, N indicates the computation amount of the FFT operation, and W_{N} is called a twiddle factor.

In general, the data sequence x(n) is also assumed to be complex valued. Conversely, the inverse DFT (IDFT) can be represented according to the following formula:

$$x ( n ) = \frac{1}{N} {\sum }_{n = 0}^{N - 1} x ( k ) {W}_{N}^{- nk} , 0 \underline{<} n \underline{<} N - 1$$

where n is a time index, k is a frequency index, N indicates the computation amount of the FFT operation, and W_{N} is a twiddle factor.

In light of this disclosure, those skilled in the art will recognize that since DFT and IDFT involve basically the same type of computations, computational algorithms and methods for the DFT described in the present disclosure are applicable to the computation of the IDFT.

For each value of k, direct computation of X(k) involves N complex multiplications and N−1 complex additions. Consequently, to compute all N values of the DFT requires N² complex multiplications and N²−N complex additions.

Direct computation of the DFT is rather inefficient primarily because it does not exploit the symmetry and periodicity properties of the twiddle factor W_{N}. For example, the symmetry and periodicity properties can be characterized as follows:

Symmetry property: W_{N}^{k+N/2}=−W_{N}^{k}

Periodicity property: W_{N}^{k+N}=W_{N}^{k}

The computationally efficient algorithms, known collectively as fast Fourier transform (FFT) algorithms, exploit these two basic properties of the twiddle factor.

For illustrative purposes, the radix-4 decimation-in-frequency algorithm is derived by breaking the N-point DFT formula into four smaller DFTs as follows:

$$\begin{matrix}X ( k ) = {\sum }_{n = 0}^{N - 1} x ( n ) {W}_{N}^{kn} \\ = {\sum }_{n = 0}^{N / 4 - 1} x ( n ) {W}_{N}^{kn} + {\sum }_{n = N / 4}^{N / 2 - 1} x ( n ) {W}_{N}^{kn} + {\sum }_{n = N / 2}^{3 N / 4 - 1} x ( n ) {W}_{N}^{kn} + {\sum }_{n = 3 N / 4}^{N - 1} x ( n ) {W}_{N}^{kn} \\ = {\sum }_{n = 0}^{N / 4 - 1} x ( n ) {W}_{N}^{kn} + {W}_{N}^{Nk / 4} {\sum }_{n = 0}^{N / 4 - 1} x ( n + \frac{N}{4} ) {W}_{N}^{kn} + {W}_{N}^{Nk / 2} {\sum }_{n = 0}^{N / 4 - 1} x ( n + \frac{N}{2} ) \\ {W}_{N}^{kn} + {W}_{N}^{3 Nk / 4} {\sum }_{n = 0}^{N / 4 - 1} x ( n + \frac{3 N}{4} ) {W}_{N}^{kn}\end{matrix}$$

The twiddle factor may also be expressed as follows,

W_{N}^{kN/4}=(−j)^{k}, W_{N}^{kN/2}=(−l)^{k}, W_{N}^{3kN/4}=(j)^{k}

Incorporating these properties of the twiddle factor, the DFT can be further expressed as follows:

$$X ( k ) = {\sum }_{n = 0}^{N / 4 - 1} [ x ( n ) + {( - j )}^{k} x ( n + \frac{N}{4} ) + {( - 1 )}^{k} k ( n + \frac{N}{2} ) + {( j )}^{k} x ( n + \frac{3 N}{4} ) ] {W}_{N}^{nk}$$

The DFT in this equation is an N-point DFT rather than an N/4-point DFT because the twiddle factor depends on N. To convert the DFT into an N/4-point DFT, the DFT sequence is sub-divided into four N/4-point subsequences, X(4k), X(4k+1), X(4k+2), and X(4k+3), k=0, 1, . . . , N/4. Using the property W_{N}^{4kn}=W^{knN/4}, the following radix-4 decimation-in frequency DFTs are thus obtained:

$$\begin{matrix}X ( 4 k ) = {\sum }_{n = 0}^{N / 4 - 1} [ x ( n ) + x ( n + \frac{N}{4} ) + x ( n + \frac{N}{2} ) + x ( n + \frac{3 N}{4} ) ] {W}_{N}^{0} {W}_{N / 4}^{kn} \\ X ( 4 k + 1 ) = {\sum }_{n = 0}^{N / 4 - 1} [ x ( n ) - j x ( n + \frac{N}{4} ) - x ( n + \frac{N}{2} ) + j x ( n + \frac{3 N}{4} ) ] {W}_{N}^{n} {W}_{N / 4}^{kn} \\ X ( 4 k + 2 ) = {\sum }_{n = 0}^{N / 4 - 1} [ x ( n ) - x ( n + \frac{N}{4} ) + x ( n + \frac{N}{2} ) - x ( n + \frac{3 N}{4} ) ] {W}_{N}^{2 n} {W}_{N / 4}^{kn} \\ X ( 4 k + 3 ) = {\sum }_{n = 0}^{N / 4 - 1} [ x ( n ) + j x ( n + \frac{N}{4} ) - x ( n + \frac{N}{2} ) - j x ( n + \frac{3 N}{4} ) ] {W}_{N}^{3 n} {W}_{N / 4}^{kn}\end{matrix}$$

In these DFTs, the input to each N/4-point DFT is a linear combination of four signal samples scaled by a twiddle factor. This decimation procedure can be repeated again and again until the resulting data sequences are reduced to one-point sequences. For N=4^{v}, the decimation process can be repeated v times, where v=log₄N. For example, if the number of input samples N is 64, then the above procedure can be repeated three times.

To compute each N/4-point DFT, complex additions and complex multiplications are required. Specifically, complex multipliers are required for the multiplication by twiddle factors

### (W_{N}⁰, W_{N}ⁿ, W_{N}²ⁿ, W_{N}³ⁿ).

Conventional FFT methods typically calculate the complex multiplication using complex multipliers. In contrast, the present embodiment employs a Distributed Arithmetic (DA) block instead of multipliers. As used herein, a distributed arithmetic operation is a bit-serial computation operation that forms an inner (dot) product of a pair of vectors in a single direct step. For example, generating a direct DA inner-product may calculate the following sum of products:

$$y = {\sum }_{k = 1}^{K} {A}_{k} {x}_{k}$$

where Aₖ are fixed coefficients and xₖ are the input data words.

In this example, if each xₖ is a 2's-complement binary number scaled such that |xₖ|<1, then each xₖ can expressed as follows:

$${x}_{k} = - {b}_{ko} + {\sum }_{n = 1}^{N - 1} {b}_{kn} {2}^{- n}$$

where bₖₙ is a bit 0 or 1, bₖ₀ is the sign bit, and b_{j, N-1} is the least significant bit (LSB).

Then, y can be expressed in terms of the bits of xₖ as follows:

$$y = {\sum }_{k = 1}^{K} {A}_{k} [ - {b}_{ko} + {\sum }_{n = 1}^{N - 1} {b}_{kn} {2}^{- n} ]$$

This equation for y is a conventional form of expressing the inner product. The equation can be further expressed in terms of a “lumped” arithmetic computation by interchanging the order of the summations as follows:

$$y = {\sum }_{n = 1}^{N - 1} [ {\sum }_{k = 1}^{K} {A}_{k} {b}_{kn} ] {2}^{- n} + {\sum }_{k = 1}^{K} {A}_{k} ( - {b}_{k 0} )$$

This equation defines a distributed arithmetic computation. The bracketed term in this equation is as follows:

$${\sum }_{K = 1}^{K} {A}_{k} {b}_{kn}$$

Because each bₖₙ may take on values of 0 and 1 only, this expression may have only 2^{k} possible values. Rather than computing these values in real time, the values may be pre-computed and stored in a memory such as a read-only memory (ROM). Although this embodiment employs a ROM, any memory such as a random access memory (RAM), Flash memory or other storage device that can pre-store the values can be used in other embodiments. Once the values are stored in the memory, the input data can be used to directly address the memory and the result, i.e.,

$${\sum }_{K = 1}^{K} {A}_{k} {b}_{kn}$$

, can be stored into an accumulator. After N such cycles, the memory contains the result y.

As an example, if K=4, A₁=0.72, A₂=−0.30, A₃=0.95, and A₄=0.11 (i.e., y=0.72x₁−0.30x₂+0.95x₃+0.11x₄), the memory contains all possible combinations (2⁴=16 values) and their negatives in order to accommodate the term

$${\sum }_{K = 1}^{K} {A}_{k} ( - {b}_{k 0} )$$

, which occurs at the sign-bit time. As a consequence, a 2·2^{k} word ROM is used in this example.

FIG. 3 shows an exemplary distributed arithmetic (DA) block 300 that performs multiplication operations by using a distributed arithmetic in the FFT processor 250 in accordance with one embodiment. The DA block 300 includes a 32-word ROM 310, an adder 320, a shifter 330, and a switch 340. In this example, because k is four, 32 (2·2⁴=32) word ROM is used.

The data X₁, X₂, X₃ and X₄ input to the ROM 310 are serial numbers corresponding to the ROM address words. A Ts bit is also provided to the ROM 310 to indicate whether the input signals are the most significant bits (MSBs). Each of these data X₁, X₂, X₃, X₄, and Ts is delivered to the ROM 310 in a one-bit-at-a-time fashion, with LSBs {b_{k, N-1}} first. These five bits form an address for the 32-word ROM 310, which outputs a value stored at the corresponding address.

To implement the distributed arithmetic in this embodiment, the equation y=0.72x₁−0.30x₂+0.95x₃+0.11x₄ is determined bitwise and the results are stored in the ROM 310 in advance as shown in Table 1, where b₁ₙ, b₂ₙ, b₃ₙ, b₄ₙ indicate the n-th bit of X₁, X₂, X₃, X₄, respectively.

TABLE 1
The contents of the 32-word ROM 310

| | Input Code | | | | | 32-Word |
|---|---|---|---|---|---|---|
| | T_{S} | b₁ₙ | b₂ₙ | b₃ₙ | b₄ₙ | Memory Contents |
| 1 ≦ n ≦ N − 1 | 0 | 0 | 0 | 0 | 0 | 0 |
| | 0 | 0 | 0 | 0 | 1 | A₄ = 0.11 |
| | 0 | 0 | 0 | 1 | 0 | A₃ = 0.95 |
| | 0 | 0 | 0 | 1 | 1 | A₃ + A₄ = 1.06 |
| | 0 | 0 | 1 | 0 | 0 | A₂ = −0.30 |
| | 0 | 0 | 1 | 0 | 1 | A₂ + A₄ = −0.19 |
| | 0 | 0 | 1 | 1 | 0 | A₂ + A₃ = 0.65 |
| | 0 | 0 | 1 | 1 | 1 | A₂ + A₃ + A₄ = 0.75 |
| | 0 | 1 | 0 | 0 | 0 | A₁ = 0.72 |
| | 0 | 1 | 0 | 0 | 1 | A₁ + A₄ = 0.83 |
| | 0 | 1 | 0 | 1 | 0 | A₁ + A₃ = 1.67 |
| | 0 | 1 | 0 | 1 | 1 | A₁ + A₃ + A₄ = 1.78 |
| | 0 | 1 | 1 | 0 | 0 | A₁ + A₂ = 0.42 |
| | 0 | 1 | 1 | 0 | 1 | A₁ + A₂ + A₄ = 0.53 |
| | 0 | 1 | 1 | 1 | 0 | A₁ + A₂ + A₃ = 1.37 |
| | 0 | 1 | 1 | 1 | 1 | A₁ + A₂ + A₃ + A₄ = 1.48 |
| n = 0 | 1 | 0 | 0 | 0 | 0 | 0 |
| | 1 | 0 | 0 | 0 | 1 | −A₄ = −0.11 |
| | 1 | 0 | 0 | 1 | 0 | −A₃ = −0.95 |
| | 1 | 0 | 0 | 1 | 1 | −(A₃ + A₄) = −1.06 |
| | 1 | 0 | 1 | 0 | 0 | −A₂ = +0.30 |
| | 1 | 0 | 1 | 0 | 1 | −(A₂ + A₄) = +0.19 |
| | 1 | 0 | 1 | 1 | 0 | −(A₂ + A₃) = −0.65 |
| | 1 | 0 | 1 | 1 | 1 | −(A₂ + A₃ + A₄) = −0.75 |
| | 1 | 1 | 0 | 0 | 0 | −A₁ = −0.72 |
| | 1 | 1 | 0 | 0 | 1 | −(A₁ + A₄) = −0.83 |
| | 1 | 1 | 0 | 1 | 0 | −(A₁ + A₃) = −1.67 |
| | 1 | 1 | 0 | 1 | 1 | −(A₁ + A₃ + A₄) = −1.78 |
| | 1 | 1 | 1 | 0 | 0 | −(A₁ + A₂) = −0.42 |
| | 1 | 1 | 1 | 0 | 1 | −(A₁ + A₂ + A₄) = −0.53 |
| | 1 | 1 | 1 | 1 | 0 | −(A₁ + A₂ + A₃) = −1.37 |
| | 1 | 1 | 1 | 1 | 1 | −(A₁ + A₂ + A₃ + A₄) = −1.48 |

In Table 1, each of b₁ₙ, b₂ₙ, b₃ₙ, b₄ₙ bits functions as an address input bit for the ROM 310. For example, if an input data (b₁ₙ, b₂ₙ, b₃ₙ, b₄ₙ) is “0100” and the sign bit input Ts is “0,” then the value “−0.30” stored at an address “00100” in the ROM 310 is output from the ROM 310.

In the embodiment, DA block 300 depicted in FIG. 3, in response to the input address, the ROM 310 provides an output value to an adder 320, which adds the output value and an output value from the shifter 330. The shifter 330 functions to shift an input value to the right by one bit and may be implemented using any suitable device or devices for such a function such as a shift register. The switch 340 is provided between the output of the adder 320 and the input of the shifter 330. Initially, while the DA block 300 is computing a y value through iterative process, the switch 340 connects the output of the adder 320 and the input of the shifter 330 to provide the output of the adder 320 as an input to the shifter 330. This operation repeats as many times as the number of bits of the input signals x₁, x₂, x₃, x₄. For example, if 16-bit signals are inputted, that operation is performed 16 times. Thus, a resulting value is calculated through sixteen additions.

When all input signals have been processed, the switch 340 connects the output of the adder 320 to an output terminal of the DA block 300 so that the output value from the adder 320 is output as a resulting value y for the DA block 300.

The FFT processor 250 in this embodiment implements the distributed arithmetic technique for calculation of various FFT output values. For example, the above described radix-4 decimation-in frequency DFTs with an input sample number N of 64, the above distributed arithmetic process is repeated three times.

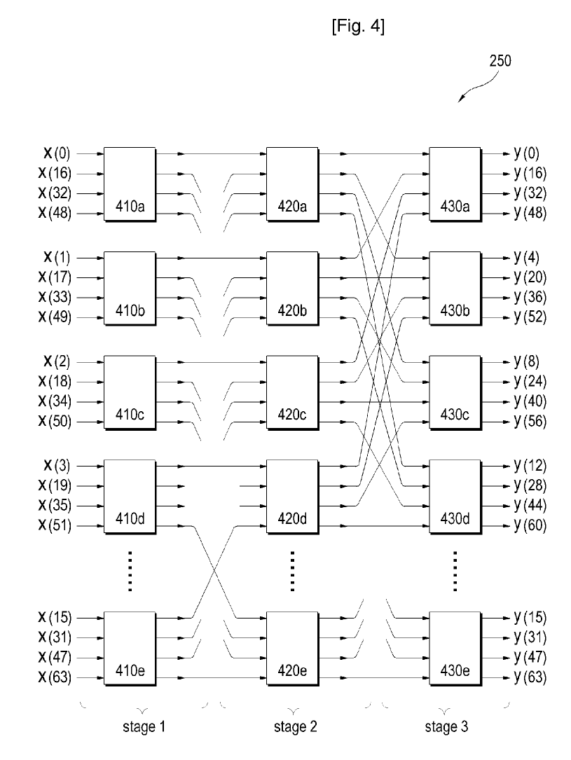

FIG. 4 illustrates a schematic diagram of the FFT processor 250 implementing a 64-point radix-4 decimation-in-frequency FFT in accordance with one embodiment. As shown, the FFT processor 250 receives 64 input values x(0)-x(63) and generates 64 output values y(0)-y(63). Although this embodiment is described using a 64-point FFT, those skilled in the art will recognize that it is applicable to other FFTs such as a 2048-point FFT, which is typically used in OFDM for DMB.

The FFT processor 250 includes three stages: stage 1, stage 2, and stage 3. Each of the stages 1, 2, and 3 includes sixteen FFT processing units 410a-410e, 420a-420e, and 430a-430e, respectively, for computing subtotals, which are then used as input values for the next stage. Each FFT processing unit is configured in this embodiment to perform identical operations on associated input data. The number of stages in the processor 250 is decided by the size of the FFT to be calculated and also by the radix used. For example, if the 64-point radix-4 FFT algorithm is used, then the number of stages is three (=log₄64).

While the FFT processor 250 is shown with respect to the 64-point radix-4 FFT algorithm, those skilled in the art will recognize that it is applicable to other algorithms such as the radix-2 algorithm or the radix-4 decimation-in-time (DIT) algorithm in other embodiments.

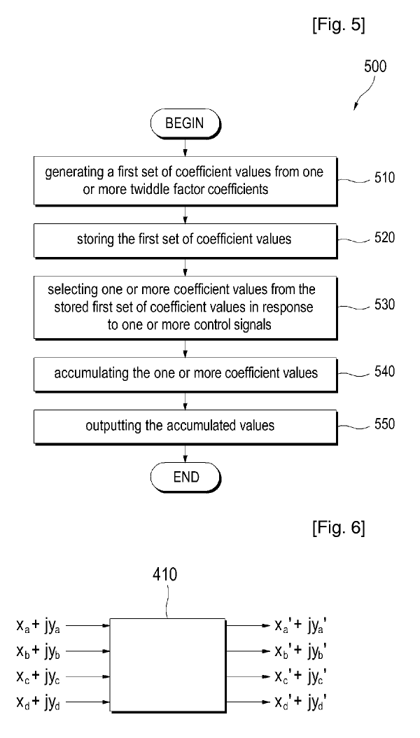

FIG. 5 is a schematic flow chart showing a method 500 for performing an FFT operation according to one embodiment. The method 500 may be used in the FFT processing units 410a-410e, 420a-420e, and 430a-430e, but those skilled in the art will recognize that any other suitable apparatus can practice the method 500.

At step 510, a first set of coefficient values is generated from one or more twiddle factor coefficients. At step 520, the first set of coefficient values is stored in a memory. At step 530, one or more coefficient values are selected from the stored first set of coefficient values in response to one or more control signals. At step 540, the one or more coefficient values are accumulated. At step 550, the accumulated values are outputted.

FIG. 6 shows a more detailed schematic diagram of an FFT processing unit 410 illustrating input and output signals in accordance with one embodiment. The FFT processing unit 410 receives and processes four input data: xₐ+jyₐ, x_{b}+jy_{b}, x_{c}+jy_{c}, and x_{d}+jy_{d}. Upon receiving the input data, the FFT processing unit 410 generates four output data according to the following complex butterfly operation:

xₐ′+jyₐ′={(xₐ+jyₐ)+(x_{b}+jy_{b})+(x_{c}+jy_{c})+(x_{d}+jy_{d})}W⁰

x_{b}′+jy_{b}′={(xₐ+jyₐ)−j(x_{b}+jy_{b})−(x_{c}+jy_{c})+j(x_{d}+jy_{d})}Wⁿ

x_{c}′+jy_{c}′={(xₐ+jyₐ)−(x_{b}+jy_{b})+(x_{c}+jy_{c})−(x_{d}+jy_{d})}W²ⁿ

x_{d}′+jy_{d}′={(xₐ+jyₐ)+j(x_{b}+jy_{b})−(x_{c}+jy_{c})−j(x_{d}+jy_{d})}W³ⁿ

After generating the output data, the FFT processing unit 410 outputs the four output data: xₐ′+jyₐ′, x_{b}′+jy_{b}′, x_{c}′+jy_{c}′, and x_{d}′+jy_{d}′. Although the input data, twiddle factors and output data are represented as complex numbers having real parts and imaginary parts, those skilled in the art will recognize that other embodiments can be adapted for input data, twiddle factors and output data having real or imaginary parts only.

Referring to FIG. 6 and its mathematic equations, each part of the first output (xₐ′+jyₐ′) of the butterfly operation can be expressed as follows:

xₐ′=xₐ+x_{b}+x_{c}+x_{d}

yₐ′=yₐ+y_{b}+y_{c}+y_{d}

The first output (xₐ′, yₐ′) of the butterfly operation does not need a complex multiplication because W⁰ is 1.

The twiddle factors can be expressed as follows:

$${W}^{n} = {e}^{- \frac{2 π n}{N}} = cos \frac{2 π n}{N} - j sin \frac{2 π n}{N} = {C}_{b} + j ( - {S}_{b} )$$

$${W}^{2 n} = {e}^{- j \frac{2 π 2 n}{N}} = cos \frac{4 π n}{N} - j sin \frac{4 π n}{N} = {C}_{c} + j ( - {S}_{c} )$$

$${W}^{3 n} = {e}^{- j \frac{2 π 3 n}{N}} = cos \frac{6 π n}{N} - j sin \frac{6 π n}{N} = {C}_{d} + j ( - {S}_{d} )$$

Then, the second output (x_{b}′+jy_{b}′) of the butterfly operation is

$$\begin{matrix}{x}_{b}^{′} + j {y}_{b}^{′} = \{ ( {x}_{a} + j {y}_{a} ) - j ( {x}_{b} + j {y}_{b} ) - ( {x}_{c} + j {y}_{c} ) + \\ j ( {x}_{d} + j {y}_{d} ) \} \{ {C}_{b} + j ( - {S}_{b} ) \} \\ = \{ ( {x}_{a} + {y}_{b} - {x}_{c} - {y}_{d} ) + j ( {y}_{a} - {x}_{b} - {y}_{c} + {x}_{d} ) \} \\ \{ {C}_{b} + j ( - {S}_{b} ) \}\end{matrix}$$

The second output can be divided into a real part and an imaginary part as follows:

$$\begin{matrix}{x}_{b}^{′} = ( {x}_{a} + {y}_{b} - {x}_{c} - {y}_{d} ) {C}_{b} - j ( {y}_{a} - {x}_{b} - {y}_{c} + {x}_{d} ) ( - {S}_{d} ) \\ = {x}_{1} {C}_{b} - {x}_{2} ( - {S}_{b} )\end{matrix}$$

$$\begin{matrix}{y}_{b}^{′} = ( {y}_{a} - {x}_{b} - {y}_{c} + {x}_{d} ) {C}_{b} + ( {x}_{a} + {y}_{b} - {x}_{c} - {y}_{d} ) ( - {S}_{b} ) \\ = {x}_{2} {C}_{b} + {x}_{1} ( - {S}_{b} ) ,\end{matrix}$$

where x₁=xₐ+y_{b}−x_{c}−x_{d} and x₂=yₐ−x_{b}−x_{c}+x_{d}.

Accordingly, in the process of calculating the second output data (and the third output data and the fourth output data, which is described later), additions and complex multiplications of input data are required. Hereinafter, additions of input data that are performed in a butterfly operation are called “butterfly addition operation.” Those skilled in the art will recognize that the butterfly addition operation also includes subtraction, which may be implemented with an adder and a negative input.

Similarly, the third output (x_{c}′+jy_{c}′) of the butterfly operation is

$$\begin{matrix}{x}_{c}^{′} + j {y}_{c}^{′} = \{ ( {x}_{a} + j {y}_{a} ) - ( {x}_{b} + j {y}_{b} ) + ( {x}_{c} + j {y}_{c} ) - ( {x}_{d} + j {y}_{d} ) \} \\ \{ {C}_{c} + j ( - {S}_{c} ) \} \\ = \{ ( {x}_{a} - {x}_{b} + {x}_{c} - {x}_{d} ) + j ( {y}_{a} - {y}_{b} + {y}_{c} - {x}_{d} ) \} \\ \{ {C}_{c} + j ( - {S}_{c} ) \}\end{matrix}$$

The third output can be divided into a real part and an imaginary part as follows:

$$\begin{matrix}{x}_{c}^{′} = ( {x}_{a} - {x}_{b} - {x}_{c} - {x}_{d} ) ( {C}_{c} - ( {y}_{a} - {y}_{b} + {y}_{c} - {y}_{d} ) ( - {S}_{c} ) \\ = {x}_{3} {C}_{c} - {x}_{4} ( - {S}_{c} )\end{matrix}$$

$$\begin{matrix}{y}_{c}^{′} = ( {y}_{a} - {y}_{b} + {y}_{c} - {y}_{d} ) {C}_{c} + ( {x}_{a} - {x}_{b} + {x}_{c} - {x}_{d} ) ( - {S}_{c} ) \\ = {x}_{4} {C}_{c} + {x}_{3} ( - {S}_{c} )\end{matrix}$$

where x₃=xₐ−x_{b}+x_{c}−x_{d} and x₄=yₐ−y_{b}+y_{c}−y_{d}.

The fourth output (xd′+jyd′) of the butterfly operation is

$$\begin{matrix}{x}_{d}^{′} + j {y}_{d}^{′} = \{ ( {x}_{a} + j {y}_{a} ) + j ( {x}_{b} + j {y}_{b} ) - ( {x}_{c} + j {y}_{c} ) - \\ j ( {x}_{d} + j {y}_{d} ) \} \{ {C}_{d} + j ( - {S}_{d} ) \} \\ = \{ ( {x}_{a} - {y}_{b} - {x}_{c} + {y}_{d} ) + j ( {y}_{a} + {x}_{b} - {y}_{c} - {x}_{d} ) \} \\ \{ {C}_{d} + j ( - {S}_{d} ) \}\end{matrix}$$

The fourth output can be divided into a real part and an imaginary part as follows:

$$\begin{matrix}{x}_{d}^{′} = ( {x}_{a} - {y}_{b} - {x}_{c} + {y}_{d} ) {C}_{d} - ( {y}_{a} + {x}_{b} + {y}_{c} + {x}_{d} ) ( - {S}_{d} ) \\ = {x}_{5} {C}_{d} - {x}_{6} ( - {S}_{d} )\end{matrix}$$

$$\begin{matrix}{y}_{d} = ( {y}_{a} + {x}_{b} - {y}_{c} - {x}_{d} ) {C}_{d} + ( {x}_{a} - {x}_{b} - {x}_{c} + {y}_{d} ) ( - {S}_{d} ) \\ = {x}_{6} {C}_{d} + {x}_{5} ( - {S}_{d} )\end{matrix}$$

where x₅=xₐ−y_{b}−x_{c}+y_{d} and x₆=yₐ+x_{b}−y_{c}−x_{d}.

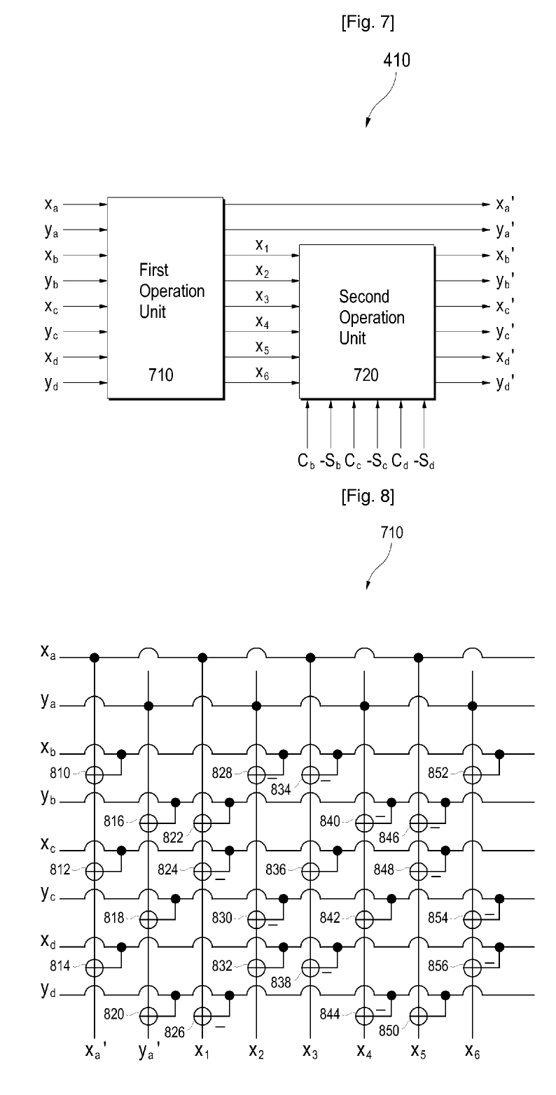

FIG. 7 shows a block diagram of an exemplary FFT processing unit 410 for performing FFT operations in accordance with one embodiment. The FFT processing unit 410 includes a first operation unit 710 and a second operation unit 720. The eight input values (xₐ-x_{d}, yₐ-y_{d}) of the FFT processing unit 410 correspond to real and imaginary parts of the four input data shown in FIG. 6, and the eight output values (xₐ′-x_{d}′, yₐ′-y_{d}′) of the FIT processing unit 410 correspond to real and imaginary parts of the four output data depicted in FIG. 6.

The first operation unit 710 performs butterfly addition operations on the input values (xₐ-x_{d}, yₐ-y_{d}) to generate first operation values (xₐ′, yₐ′, x₁, x₂, x₃, x₄, x₅, x₆).

The second operation unit 720 coupled to the first operation unit 710 to receive first operation values x₁-x₆ along with real part coefficients (C_{b}, C_{c}, C_{d}), and imaginary part coefficients (−S_{b}, −S_{c}, −S_{d}) of the twiddle factors. The second operation unit 720 performs multiplication operations on the received values and the twiddle factors using the distributed arithmetic method (hereinafter, “butterfly DA operation”). The resulting values (x_{b}′-x_{d}′, y_{b}′-y_{d}′) from the second operation unit 720 and the xₐ′ and yₐ′ values from the first operation unit 710 are then provided as output data.

FIG. 8 shows a more detailed schematic diagram of the first operation unit 710 according to one embodiment. The first operation unit 710 includes a plurality of adders 810-856 that are arranged to receive input data (xₐ-x_{d}, and yₐ-y_{d}) to generate output data xₐ′, yₐ′, and x₁-x₆. For illustration purposes, the adders are arranged in columns and rows such that the adders 810-856 in each of the eight columns operate to perform butterfly addition operations to output the respective output values (xₐ′, yₐ′, and x₁-x₆). For example, in order to generate the output data x₁ (=xₐ+y_{b}−x_{c}−y_{d}), the adder 822 adds input data xₐ and y_{b}, the adder 824 subtracts x_{c} from an output value (xₐ+y_{b}) of the adder 822, and the adder 826 subtracts y_{d} from an output value (xₐ+y_{b}−x_{c}) of the adder 824. The adder 826 then outputs the result as value x₁. Other output values (xₐ′, yₐ′, x₂-x₆) are generated in a similar manner using the associated adders 810-820 and 828-856.

In one embodiment, the first output data (xₐ′ and yₐ′) does not require further operation (e.g., complex multiplication). Thus, these values are provided directly from the first operation unit 710 as outputs of the FFT processing unit 410 without further processing in the second operation unit 720.

In light of this disclosure, those skilled in the art will recognize that the first operation unit 710 can be easily implemented by using a plurality of adders, and the configuration of the first operation unit 710 can be modified or varied without departing the spirit and scope of the present invention.

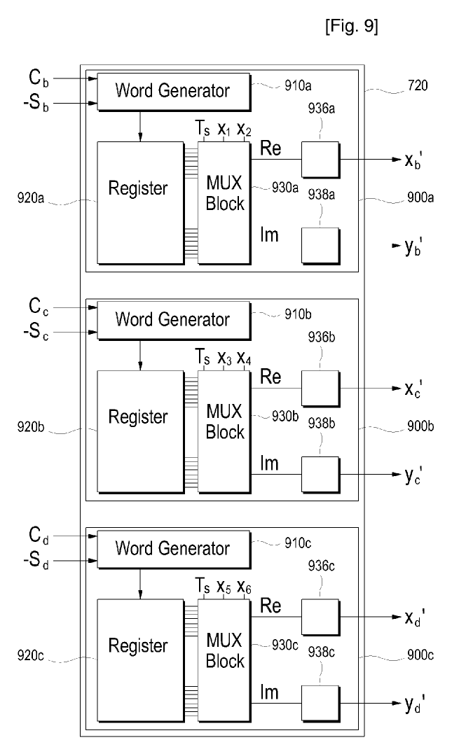

FIG. 9 shows a more detailed schematic diagram of the second operation unit 720 according to one embodiment. The second operation unit 720 includes distributed arithmetic (DA) units 900a, 900b, and 900c arranged in parallel. The DA unit 900a is configured to generate x_{b}′ and y_{b}′ output values from input values x₁ and x₂ and twiddle factors C_{b} and S_{b}. Similarly, the DA unit 900b is arranged to generate x_{c}′ and y_{c}′ from input values x₃ and x₄ and twiddle factors C_{c} and −S_{c} while the DA unit 900c is configured to generate output values x_{d}′ and y_{d}′ from input values x₅ and x₆ and twiddle factors C_{d} and S_{d}.

The DA unit 900a includes a word generator 910a, a register 920a, a multiplexer block 930a, and a pair of accumulator circuits 936a and 938a. The other DA units 900b and 900c include identical components and operate on their input data in a similar manner as the DA unit 900a described herein, and thus are not separately discussed in detail. The word generator 910a (i.e., coefficient generator) receives the coefficients of the twiddle factors (C_{b}, −S_{b}) to determine all possible values that can result from the coefficients. In this embodiment, the word generator 910a determines eight possible values (S_{b}, −S_{b}, C_{b}, −C_{b}, C_{b}+S_{b}, −C_{b}−S_{b}, −S_{b}+C_{b}, S_{b}−C_{b}), which are provided to the register 920a for storage. Table 2 shows the eight possible set of values which are stored at respective addresses (Ts, x₁ₙ, and x₂ₙ) of the register 920a by the word generator 910a where n indicates n-th bit of x₁ and x₂. Each set includes a real value Re and an imaginary value Im. Although this embodiment is described using the register 920a, in light of this disclosure those skilled in the art will appreciate that other embodiments may employ any memory devices such as RAM, ROM, etc.

TABLE 2
Contents of register 920a

| | Ts | x₁ₙ | x₂ₙ | Re | Im |
|---|---|---|---|---|---|
| n ≠ 0 | 0 | 0 | 0 | 0 | 0 |
| | 0 | 0 | 1 | Sb | Cb |
| | 0 | 1 | 0 | Cb | −Sb |
| | 0 | 1 | 1 | Cb + Sb | −Sb + Cb |
| n = 0 | 1 | 0 | 0 | 0 | 0 |
| | 1 | 0 | 1 | −Sb | −Cb |
| | 1 | 1 | 0 | −Cb | Sb |
| | 1 | 1 | 1 | −Cb − Sb | Sb − Cb |

The real values (Re) and imaginary values (Im) stored in the register 920a are provided to the multiplexer block 930a as input data. The multiplexer block 930a also receives three control data signals Ts, x₁, and x₂ used to select the input data for output. The x₁ and x₂ data correspond to the register 920a address words and are serial numbers. The Ts data indicates that input signals are most significant bits (MSBs), and has a value 1 when input bits are the MSB bits of x₁ and x₂, respectively. Each of x₁, x₂ and Ts data is provided to the multiplexer block 930a in a one-bit-at-a-time fashion, with LSBs {x_{k, N-1}} first. These three bits form an address for the multiplexer block 930a, which selects a set of Re and Im values according to the control address bits.

The multiplexer block 930a then outputs the Re value and an Im value, which are provided to the accumulator circuits 936a and 938a, respectively, in series for accumulation. Specifically, the accumulator circuit 936a receives the Re value in series and accumulates the received Re values to generate an x_{b}′ value by performing a series of addition operations. Similarly, the accumulator circuit 938a receives and accumulates the Im value in series to generate an y_{b}′ value by performing a series of additional operations. The accumulated values are then output by the accumulator circuits 936a and 938a as x_{b}′ and y_{b}′ data, respectively.

The DA units 900b and 900c operate in a similar manner as the DA unit 900a. Specifically, the butterfly DA unit 900b includes a word generator 910b, a register 920b, a multiplexer block 930b, and accumulator circuits 936b and 938b for generating the third output data (x_{c}′, y_{c}′). The word generator 910b receives the coefficients of the twiddle factors (C_{c}, −S_{c}) to generate all possible values that can result from the coefficients. The word generator 910b stores the generated values in the register 920a.

Table 3 shows values which are stored at respective addresses of the register 920b by the word generator 910b, where n indicates n-th bit of x₃ and x₄.

TABLE 3
The contents of the register 920b

| | Ts | x₃ₙ | x₄ₙ | Re | Im |
|---|---|---|---|---|---|
| n ≠ 0 | 0 | 0 | 0 | 0 | 0 |
| | 0 | 0 | 1 | Sc | Cc |
| | 0 | 1 | 0 | Cc | −Sc |
| | 0 | 1 | 1 | Cc + Sc | −Sc + Cc |
| n = 0 | 1 | 0 | 0 | 0 | 0 |
| | 1 | 0 | 1 | −Sc | −Cc |
| | 1 | 1 | 0 | −Cc | Sc |
| | 1 | 1 | 1 | −Cc − Sc | Sc − Cc |

From the stored values, the multiplexer block 930b selects a set of Re and Im values in response to address bits Ts, x₃, and x₄. The accumulator circuits 936b and 938b receives and accumulates the selected Re and Im value to generate output data x_{c}′ and y_{c}′ as described above with respect to the DA unit 900a.

The butterfly DA unit 900c includes a word generator 910c, a register 920c, a multiplexer block 930c, and accumulator circuits 936c and 938c for generating output data x_{d}′ and y_{d}′. The word generator 910c receives the coefficients of the twiddle factors (C_{d}, −S_{d}) to calculate all possible values that can result from the coefficients. The word generator 910c stores the generated values in the register 920c. Table 4 shows values which are stored at respective addresses of the register 920c by the word generator 910c, where n indicates n-th bit of x₅ and x₆ data.

TABLE 4
The contents of the register 920c

| | Ts | x₅ₙ | x₆ₙ | Re | Im |
|---|---|---|---|---|---|
| n ≠ 0 | 0 | 0 | 0 | 0 | 0 |
| | 0 | 0 | 1 | Sd | Cd |
| | 0 | 1 | 0 | Cd | −Sd |
| | 0 | 1 | 1 | Cd + Sd | −Sd + Cd |
| n = 0 | 1 | 0 | 0 | 0 | 0 |
| | 1 | 0 | 1 | −Sd | −Cd |
| | 1 | 1 | 0 | −Cd | Sd |
| | 1 | 1 | 1 | −Cd − Sd | Sd − Cd |

The register 920c provides the stored values to the multiplexer block 930c, which selects a set of Re and Im values in response to address bits Ts, x₅ and x₆. The selected Re and Im values are then provided to the accumulator circuits 936c and 938c, which accumulates the values to generate output data x_{d}′ and y_{d}′ as described above with respect to the DA units 900a and 900b.

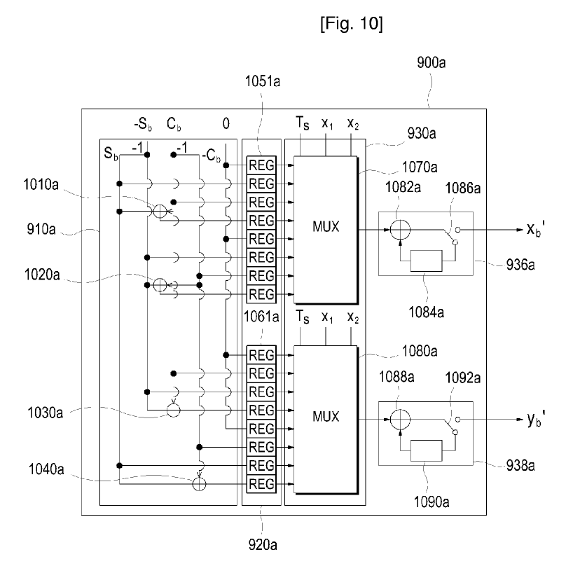

FIG. 10 shows a more detailed schematic diagram of the butterfly DA unit 900a according to one embodiment. The word generator 910a includes a plurality of adders 1010a-1040a for generating all possible values that can result from the coefficients of a corresponding twiddle factor. The register 920a includes sixteen sub-registers 1051a-1058a and 1061a-1068b for storing the possible values generated from the word generator 910a. The multiplexer block 930a includes a multiplexer 1070a for selecting a Re value from the possible Re values stored at the sub-registers 1051a-1058a and a multiplexer 1080a for selecting an Im value from the possible Im values stored at the sub-registers 1061a-1068a.

The word generator 910a is configured to generate all possible values of Re and Im values for storage in the sub-registers 1051a-1058a and 1061a-1068a as described in Table 2 above. In this embodiment, the word generator 910a generates and stores the first possible Re value, which is 0, in the sub-register 1051a. The second possible Re value is Sb, which is an inverse value of the input “−Sb,” and is generated and stored in the sub-register 1052a. The word generator 910a also generates Cb for the third possible Re value, which is stored in the sub-register 1053a. The adder 1010a in the word generator 910a generates the fourth possible Re value Cb+Sb by adding Cb and Sb. Other real and imaginary values of Table 2 can be generated similarly.

For selecting an Re and Im set of values from the register 920a, the multiplexer block 930a includes a pair of multiplexers 1070a and 1080a, which are configured to receive identical address bits Ts, x₁, and x₂. The multiplexer 1070a is arranged to receive the all possible Re values from the sub-registers 1051a-1058a while the multiplexer 1080a is configured to arranged to receive the all possible Im values from the sub-registers 1061a-1068a. In response to the address bits, the multiplexers 1070a and 1080a select and output an Re value and an Im value, respectively, from the register 920a.

To process the selected Re and Im values from the multiplexers 1070a and 1080a, the accumulator circuits 936a and 938a are configured to receive and accumulate Re and Im data values, respectively. The accumulator 936a includes an adder 1082a, a shifter 1084a, and a switch 1086a for adding the Re data bits while the accumulator 938a includes an adder 1088a, a shifter 1090a, and a switch 1092a for adding the Im data bits.

For adding the Re data, the adder 1082a receives the Re data bits in series from the multiplexer block 930a and adds each input value Re with an output value of the shifter 1084a, which initially outputs a “0” value and functions to shift its input value from the adder 1082a via the switch 1086a to the right by one bit. The switch 1086a connects the output of the adder 1082a to the input of the shifter 1084a during the computation so that each output value of the adder 1082a is inputted to the shifter 1084a. Accordingly, an output value of the multiplexer 1070a is shifted to LSB and added to the next output value of the multiplexer 1070a. Repetition of this process in the accumulator 936a generates a real part x_{b}′ data. When the real part x_{b}′ data is generated, the switch 1086a operates to output the resulting value as x_{b}′ (i.e., a real part of the second output data) to an output port of the DA unit 900a.

In a similar manner, the accumulator 938a generates the imaginary part value y_{b}′ using the adder 1088a, the shifter 1090a, and the switch 1092a. Upon generating the y_{b}′ data, completed, the switch 1092a operates to output the resulting y_{b}′ (i.e., an imaginary part of the second output data) to an output port of the DA unit 900a. In one embodiment, the DA units 900b and 900c include similar components that operate in a similar manner to generate respective output data, and are not separately discussed in detail.

The disclosed FFT processing apparatus can provide numerous advantages over conventional FFT apparatus that employ multipliers, which typically require relatively high power and large cell areas. By first generating all possible Re and Im values and storing these values in a memory device such as a register, RAM, or ROM, the disclosed FFT apparatus provides a low power and low cell area solution for numerous applications. For example, Table 5 below illustrates some of the advantages of the disclosed FFT apparatus over conventional FFT structures using multipliers in implementing a 64-point Radix-4 FFT algorithm.

TABLE 5

| | | No. of | | No. of | No. of |
|---|---|---|---|---|---|
| | | cell | No. of | subtotal | total |
| | Block name | areas | Blocks | cell areas | cell areas |
| FFT | Addition | 2,769 | 3 | 8,307 | 18,213 |
| computation | block | | | | |
| structure | DA block | 4,953 | 2 | 9,906 | |
| according | | | | | |
| to one | | | | | |
| embodiment | | | | | |
| Compared | Addition | 2,131 | 3 | 6,393 | 46,721 |
| structure | Block | | | | |
| | Multiplication | 20,164 | 2 | 40,238 | |
| | Block | | | | |

As shown in Table 5, the number of total cell areas of the disclosed FFT structure decreases from 46,721 to 18,213 in the case where the second operation unit 720 is implemented using an FFT computation structure according to one embodiment. This is a decrease of 61.02% in the total cell areas. Table 5 is an exemplary logical synthesis results for the 64-point FFT and a decrease in the cell areas for a 2048-point FFT, which is typically used in OFDM for DMB, will be even larger.

Further, Table 5 illustrates exemplary logical synthesis results only for a butterfly/twiddle block and not for the entire 64-point FFT computation structure, which uses delay converters in pipeline manner. Where an entire 64-point FFT computation structure according to one embodiment is compared with a conventional whole 64-point FFT computation structure, the embodiment may show a decrease of 46.1% in cell areas.

As such, the disclosed FFT processing apparatus requires less cell areas to implement, with attendant decrease in power consumption. Therefore, the disclosed embodiments provide an efficient FFT structure, which can be used in any suitable system requiring FFT such as an OFDM modem for DMB.

While various embodiments have been shown and described, in light of this disclosure those skilled in the art will recognize that various changes and modifications may be made.

1. A fast Fourier Transform (FFT) processing device, comprising:
a coefficient generator configured to generate a first set of coefficient values from one or more twiddle factor coefficients.
a memory arranged to store the first set of coefficient values; and
an accumulator arranged to receive and accumulate one or more coefficient values from the first set of coefficient values and to generate one or more output values based on the accumulated one or more coefficient values.

2. The device of claim 1, further comprising:
a multiplexer coupled to select the one or more coefficient values that are stored in the memory and to provide the selected one or more coefficients to the accumulator.

3. The device of claim 2, wherein the multiplexer is arranged to receive control signals for selecting the one or more coefficient values.

4. The device of claim 1, wherein the memory comprises a register.

5. The device of claim 1, wherein the memory comprises a random access memory.

6. The device of claim 1, wherein the accumulator comprises:
one or more adders configured to receive and add the one or more coefficient values one bit at a time.

7. The device of claim 6, wherein the accumulator further comprises:
one or more shifters configured to shift the output data of the adders; and
one or more switches configured to output the added values from the one or more adders as the one or more output values.

8. The device of claim 1, wherein the twiddle factor coefficients are based on a radix-4 FFT algorithm.

9. The device of claim 1, wherein the twiddle factor coefficients are based on a 64-point radix-4 algorithm.

10. The device of claim 9, wherein the twiddle factor coefficients are e^{-j2x/N} to the n-th power, where N is 64 and n is 0, 1, 2, N−1.

11. An apparatus for computing fast Fourier Transform (FFT), comprising:
a first operation unit configured to receive and add M input data to generate M data; and
a second operation unit configured to receive and process a set of the M data from the first operation unit, the second operation unit generating a set of output data values based on the set of the M data and one or more twiddle factor co-efficients.

12. The apparatus of claim 11, wherein the first operation unit further comprises:
a plurality of adders arranged to add the M input data to generate the M data.

13. The apparatus of claim 11, wherein the second operation unit further comprises:
a coefficient generator configured to generate a first set of coefficient values from one or more twiddle factor coefficients;
a memory configured to the first set of coefficient values; and
an accumulator arranged to receive and accumulate one or more coefficient values from the first set of coefficient values and to generate the set of output values based on the accumulated one or more coefficient values.

14. The apparatus of claim 13, further comprising:
a multiplexer coupled to select the one or more coefficient values that are stored in the memory and to provide the selected one or more coefficients to the accumulator.

15. The apparatus of claim 14, wherein the multiplexer is arranged to receive a subset of the M data signals from the first operation unit.

16. The apparatus of claim 13, wherein the memory comprises a register.

17. The apparatus of claim 13, wherein the memory comprises a random access memory.

18. The apparatus of claim 13, wherein the accumulator comprises:
one or more adders configured to receive and add the one or more coefficient values one bit at a time.

19. The apparatus of claim 18, wherein the accumulator further comprises:
one or more shifters configured to shift the output data of the address; and
one or more switches configured to output the added values from the one or more adders as the one or more output values.

20. The apparatus of claim 11, wherein the twiddle factor coefficients are based on a radix-4 FFT algorithm.

21. The apparatus of claim 11, wherein the twiddle factor coefficients are based on a 64-point radix-4 algorithm.

22. The apparatus of claim 21, wherein the twiddle factor coefficients are e−j2πr/N to the n-th power, where N is 64 and n is 0, 1, 2, N−1.

23. A method for performing a fast Fourier Transform (FFT) operation, comprising:
generating a first set of coefficient values from one or more twiddle factor coefficients;
storing the first set of coefficient values; and
generating one or more output values based on one or more coefficient values from the first set of coefficient values.

24. The method of claim 23, wherein the one or more output values are generated by accumulating one or more coefficient values from the first set of coefficient values.

25. The method of claim 23, wherein the operation of storing the first set of coefficient values further comprises:
selecting the one or more coefficient values that are stored in the memory.

26. The method of claim 23, wherein the one or more coefficient values are selected in response to one or more control signals.

27. The method of claim 24, wherein the twiddle factor coefficients are based on a radix-4 FFT algorithm.

28. The method of claim 24, wherein the twiddle factor coefficients are based on a 64-point radix-4 algorithm.

29. The method of claim 28, wherein the twiddle factor coefficients are e^{-j2x/N} to the n-th power, where N is 64 and n is 0, 1, 2, N−1.

30. A method for generating fast Fourier Transform (FFT) data, comprising:
receiving first M input data;
generating second M data from the first M input data by performing a plurality of addition operations; and
generating a set of output data values based on a set of the second M data and one or more twiddle factor coefficients.

31. The method of claim 30, wherein the operation of generating the set of output data further comprises:
generating a first set of coefficient values from the one or more twiddle factor coefficients;
storing the first set of coefficient values; and
generating one or more output values based on one or more coefficient values from the first set of coefficient values.

32. The method of claim 31, wherein the one or more output values are generated by accumulating one or more coefficient values from the first set of coefficient values.

33. The method of claim 31, wherein the operation of storing the first set of coefficient values further comprises:
selecting the one or more coefficient values that are stored in the memory.

34. The method of claim 33, wherein the one or more coefficient values are selected in response to one or more control signals.

35. The method of claim 30, wherein the twiddle factor coefficients are based on a radix-4 FFT algorithm.

36. The method of claim 30, wherein the twiddle factor coefficients are based on a 64-point radix-4 algorithm.

37. A mobile communications receiver for receiving radio frequency (RF) signals, comprising:
an RF unit configured to receive and convert RF signals to baseband signals;
an analog-to-digital converter configured to convert the baseband signals to digital signals; and
an FFT processor configured to perform FFT on the digital signals, the FFT processor comprising:
a coefficient generator configured to generate a first set of coefficient values from one or more twiddle factor coefficients;
a memory configured to store the first set of coefficient values; and
an accumulator arranged to receive and accumulate one or more coefficient values from the first set of coefficient values and to generate one or more output values based on the accumulated one or more coefficient values.

38. (canceled)
